(19) United States
(12) Patent Application Publication
(10) Pub. No.: US 2009/0244360 A1
(43) Pub. Date: Oct. 1, 2009

(54) Camera System And Camera Body Composing The Same

(75) Inventors: Hiroshi Ueda, Osaka (JP); Hidekazu Nakajima, Osaka (JP); Taizo Aoki, Hyogo (JP)

Correspondence Address: PANASONIC PATENT CENTER, 1130 CONNECTICUT AVENUE NW, SUITE 1100, WASHINGTON, DC, 20036, US

(73) Assignee: PANASONIC CORPORATION, Osaka (JP)

(21) Appl. No.: 12/411,619

(22) Filed: Mar. 26, 2009

(30) Foreign Application Priority Data
Mar. 28, 2008 (JP) 2008-086056

(51) Int. Cl. H04N 5/225; H04N 5/235

(52) U.S. Cl. 348/360; 348/362; 348/373; 348/E05.034; 348/E05.024

(57) ABSTRACT

A camera system includes a controller operable to control operations of a camera body and an interchangeable lens. When supply of power from a power supply of the camera body is requested to be stopped, the controller performs control to adjust an aperture of the diaphragm such that an amount of light passing through the diaphragm is no greater than a predetermined value, and thereafter, to stop the supply of power.

### BACKGROUND

1. Technical Field

The technical field relates to a lens-interchangeable camera system and more particularly to control of the camera system upon power-off.

2. Related Art

A single-lens reflex camera to which an interchangeable lens is mountable has a movable mirror in a camera body thereof. Normally, the movable mirror is located in an observation position and light incident to the interchangeable lens is reflected by the movable mirror and the reflected light is further guided to a viewfinder through a prism provided at an upper part of the camera body. An operator can check a shooting target from the viewfinder. Upon taking a picture, the movable mirror momentarily is flipped up to move to a shooting position. Thus, the incident light through the interchangeable lens is guided to film loaded in the camera body and exposes the film so that an image can be recorded.

In such a single-lens reflex camera, when a power switch is turned off with a movable mirror flipped up, the mirror remains at the shooting position. When an erroneous operation in this situation is performed such as carelessly detaching an interchangeable lens from a camera body, a problem is caused that the film is exposed since the film loaded in the camera is uncovered.

JP-A-2000-122172 solves the above problem in a film type single-lens reflex camera that records an image by exposing film. The single-lens reflex camera disclosed in JP-A-2000-122172 includes a body control unit that controls a camera body. When the power to the camera body is turned off by operating a mode switch dial or by auto-off control, the body control unit detects whether a film holder is placed in the camera body and controls the position of a mirror.

Specifically, if the film holder is placed, then the body control unit checks the position of the mirror by referring to a detection result from a mirror detection sensor. When the mirror is not in a viewfinder observation position, the body control unit brings down and moves the mirror to the observation position. Accordingly, an aperture of the camera body is shut optically by a light-shielding plate, and thereafter, the power to the camera body is turned off. On the other hand, if the film holder is not placed, then since there are no concerns about exposure of photographic film, the body control unit turns off power to the camera body without moving the mirror.

A digital single-lens reflex camera that has a movable mirror and that electronically records an image using an imaging element such as a CMOS image sensor has the same problem. Specifically, when light incident from the outside exposes the imaging element for a long time during power-off of a camera body with the movable mirror flipped up, there is a problem that the imaging element, i.e., color filters in the imaging element, is deteriorated.

The single-lens reflex camera disclosed in JP-A-2000-122172 has a movable mirror between an optical system and an imaging plane. Upon power-off, the movable mirror is moved in an optical path, so that exposure of film is prevented. Thus, the art disclosed in JP-A-2000-122172 can also be applied to a digital single-lens reflex camera as long as the camera has a movable mirror. However, the method disclosed in JP-A-2000-122172 cannot be applied to a digital single-lens camera that does not have a movable mirror, in order to prevent deterioration of color filters in an imaging element caused by exposure of the imaging element for a long time.

An object is therefore to provide a camera system having no movable mirror between an optical system and an imaging element and enabling determination of picture composition when imaging a still image by using a moving image displayed on display unit, that is capable of reducing deterioration of the imaging element or a color filter in the imaging element which is caused by light incident from a subject through an interchangeable lens during power-off.

### SUMMARY

In a first aspect, a camera system including a camera body and an interchangeable lens is provided. The camera system includes an optical system operable to collect light from a subject to form a subject image, a diaphragm with an aperture operable to regulate an amount of the light of the subject image, collected by the optical system, a diaphragm driver operable to drive the diaphragm, an imaging element operable to capture the subject image formed by the optical system to generate image data, a power supply operable to supply power to the camera body and the interchangeable lens, and a controller operable to control the power supply. When the supply of power from the power supply is requested to be stopped, the controller controls the diaphragm driver to adjust the aperture of the diaphragm such that an amount of light passing through the diaphragm is no greater than a predetermined value, and thereafter the controller controls the power supply to stop the supply of power.

In a second aspect, a camera system including a camera body and an interchangeable lens is provided. The interchangeable lens includes an optical system operable to collect light from a subject to form a subject image. The camera body includes a power supply operable to supply power to the camera body, an imaging element operable to capture the subject image formed by the interchangeable lens to generate image data, a barrier mechanism operable to cut off or reduce light incident through the interchangeable lens, a barrier driver operable to drive the barrier mechanism, and a controller operable to control an operation of the camera body. When the supply of power from the power supply is requested to be stopped, the controller controls the barrier driver to drive the barrier mechanism to cut off or reduce light incident through the interchangeable lens, and thereafter controls the power supply to stop the supply of power.

In a third aspect, a camera body to which an interchangeable lens including a diaphragm for regulating an amount of light of a subject image is mountable is provided. The camera body includes an imaging element operable to capture the subject image formed by the interchangeable lens to generate image data, a power supply operable to supply power to the camera body, and a controller operable to control the power supply. When the supply of power from the power supply is requested to be stopped, the controller transmits to the interchangeable lens a control signal for adjusting the aperture of the diaphragm such that an amount of light passing through the diaphragm of the interchangeable lens is no greater than a predetermined value. After receiving from the interchangeable lens a signal indicating that the adjustment to the diaphragm has been completed, the controller controls the power supply to stop the supply of power.

In a fourth aspect, a camera body to which an interchangeable lens is mountable. The camera body includes a diaphragm with an aperture operable to regulate an amount of light of a subject image which is collected by the interchangeable lens, a diaphragm driver operable to drive the diaphragm, an imaging element operable to capture the subject image formed by the interchangeable lens to generate image data, a power supply operable to supply power to the camera body, and a controller operable to control the power supply. When the supply of power from the power supply is requested to be stopped, the controller controls the diaphragm driver to adjust the aperture of the diaphragm such that an amount of light passing through the diaphragm is no greater than a predetermined value. Thereafter, the controller controls the power supply to stop the supply of power.

In a fifth aspect, a camera body to which an interchangeable lens is mountable, the camera body includes a power supply operable to supply power to the camera body, an imaging element operable to capture a subject image formed by the interchangeable lens to generate image data, a barrier mechanism operable to cut off or reduce light incident through the interchangeable lens, a barrier driver operable to drive the barrier mechanism, and a controller operable to control an operation of the camera body. When the supply of power from the power supply is requested to be stopped, the controller controls the barrier driver to drive the barrier mechanism to cut off or reduce the light incident through the interchangeable lens, and thereafter controls the power supply to stop the supply of power.

The aforementioned camera system having no movable mirror between an optical system and an imaging element and enabling determination of picture composition upon imaging a still image by using a moving image displayed on a display unit, can reduce deterioration of the imaging element caused by light incident from a subject through an interchangeable lens during power-off. Thus, deterioration of the imaging element or color filters in the imaging element can be reduced.

### BRIEF DESCRIPTION OF DRAWINGS

FIG. 1 is a block diagram showing a configuration of a camera system according to a first embodiment.

FIG. 2 is a flowchart for describing an operation performed upon power-off of the camera system according to the first embodiment.

FIG. 3 is a flowchart for describing an operation performed upon power-on of the camera system according to the first embodiment.

FIG. 4 is a block diagram showing a configuration of a camera system according to a second embodiment.

### DETAIL DESCRIPTION OF PREFERRED EMBODIMENTS

Embodiments will be described below with reference to the accompanying drawings.

### First Embodiment

### 1. Configuration

1-1. Configuration of Camera System

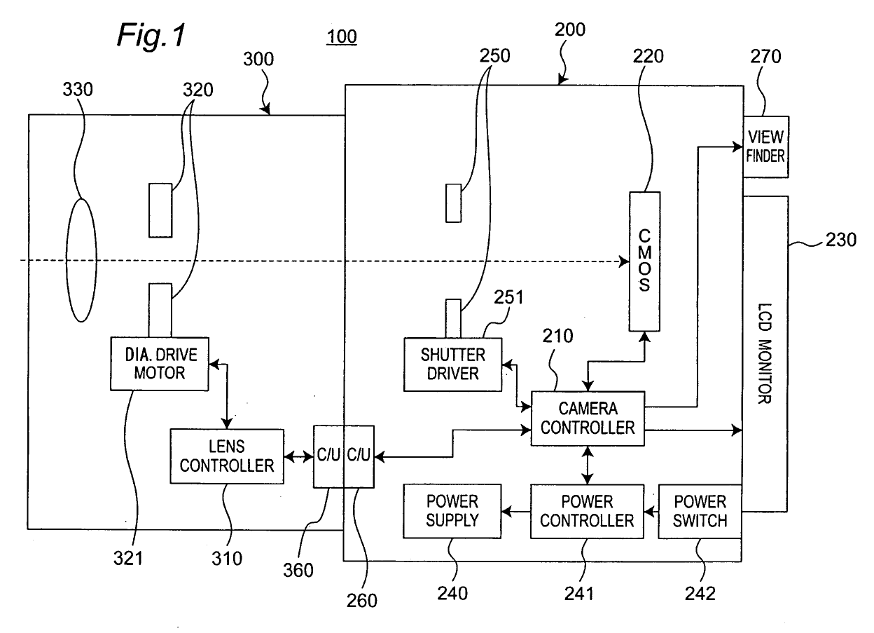

FIG. 1 is a block diagram showing a configuration of a camera system according to a first embodiment. A camera system 100 includes a camera body 200 and an interchangeable lens 300 mountable to the camera body 200.
1-2. Configuration of Camera Body

The camera body 200 includes a CMOS image sensor 220, a liquid crystal display (LCD) monitor 230, a power controller 241, a shutter driver 251, an electronic viewfinder 270, and a camera controller 210 for controlling these components. Note that the camera body 200 may include a memory card slot, a strobe, a DRAM, and soon in addition to the components shown in FIG. 1.

The CMOS image sensor 220 captures a subject image formed by the interchangeable lens 300 to generate image data. The image data generated by the CMOS image sensor 220 is subjected to processes, such as a YC conversion process, an electronic zoom process, and a compression process, in the camera controller 210. Note that although in the present embodiment, the CMOS image sensor 220 is shown as an example of an imaging element, the imaging element is not limited thereto. For example, the imaging element may be a CCD image sensor.

The LCD monitor 230 displays an image based on the image data transmitted from the camera controller 210. The LCD monitor 230 can display a moving image and a still image. While the LCD monitor 230 can display a moving image in the process of being recorded, the LCD monitor 230 can also display a moving image only for operator's visual identification during no recording operation performed. Such display of a moving image during no recording operation performed is particularly used for determination of picture composition by the operator upon recording a still image. In this specification, an operation mode which can display a moving image in real time during no recording operation performed is referred to as the “live view mode”. Note that in the present embodiment, although the LCD monitor 230 is shown as an example of display unit, the display unit is not limited thereto. For example, the display unit may be an organic EL (electroluminescence) display.

A power supply 240 is used to supply power to the camera body 200 and the interchangeable lens 300. The power supply 240 can be implemented by a battery such as a rechargeable battery or dry cell battery. Alternatively, the power supply 240 may supply power from an external source through a power cord. The power controller 241 controls supply of power from the power supply 240. The power controller 241 controls the power supply 240 based on an operation performed on a power switch 242 by the operator, to start or end supply of power. Also, when no operation is performed on the camera body 200 or the interchangeable lens 300 for a predetermined period of time, the power controller 241 activates a sleep mode to stop supply of power to part of the camera body 200 and the interchangeable lens 300. Note that the power controller 241 can be implemented by a microcomputer, a hard wired circuit arrangement, and so on. Note also that in the present embodiment, although the power controller 241 is provided separately from the camera controller 210, the camera controller 210 may include a power control function of the power controller 241.

A shutter 250 is a mechanical shutter and regulates the amount of exposure to the CMOS image sensor 220 by aperture and closing an optical path running from the interchangeable lens 300 to the CMOS image sensor 220. The CMOS image sensor 220 can perform capturing image when the shutter 250 is in an open status. The shutter driver 251 opens and closes the shutter 250 under control of the camera controller 210. The shutter 250 can be normally implemented by a focal-plane shutter, and so on.

The camera body 200 according to the present embodiment does not have a movable mirror, in the optical path from the interchangeable lens 300 to the CMOS image sensor 220, such as that provided in a conventional camera body. Thus, miniaturization of the camera body 200 is achieved. However, since the camera body 200 does not have a movable mirror, the camera body 200 cannot allow the operator to visually identify a subject image using optical means such as that provided in a conventional camera body. Hence, the camera body 200 according to the present embodiment makes the shutter 250 open in a normal state to display a moving image on the LCD monitor 230 or the electronic viewfinder 270, so that the operator can see a subject image. This is a big difference from a conventional lens-interchangeable camera which has a movable mirror.

The electronic viewfinder 270 can be implemented by a display device such as an LCD or organic EL display. The electronic viewfinder 270 is look-through type display device. Specifically, the display device is disposed in the camera body 200 and the operator can see an image displayed on the display device by looking it through a window provided to the camera body 200. The electronic viewfinder 270 can display a moving image or still image based on image data transmitted from the camera controller 210. The operator can determine picture composition upon recording an image based on an image displayed on the electronic viewfinder 270.

The camera controller 210 controls the entire camera body 200 and communicates with the interchangeable lens 300. The camera controller 210 can be implemented by a microcomputer, a hard wired circuit arrangement, and so on. Although in the present embodiment, control of the entire camera body 200 and communication with the interchangeable lens 300 are implemented by a single controller, these functions may be implemented by a plurality of controllers.

A body-side connecting unit 260 is electrically connected to a lens-side connecting unit 360. The body-side connecting unit 260 transmits a control signal sent out from the camera controller 210 to the interchangeable lens 300. The body-side connecting unit 260 transmits a response signal received from the interchangeable lens 300 to the camera controller 210. Also, the body-side connecting unit 260 outputs power supplied from the power supply 240 to the interchangeable lens 300. The body-side connecting unit 260 and the lens-side connecting unit 360 each are usually called “mount”.
1-3. Configuration of Interchangeable Lens

The interchangeable lens 300 includes an optical system 330, a diaphragm drive motor 321, and a lens controller 310 for controlling these components. The interchangeable lens 300 also includes the lens-side connecting unit 360 and thus can communicate with the camera body 200.

The optical system 330 collects light from a subject to form a subject image. Although in FIG. 1, for sake of convenience only a single lens is shown, in practice the optical system 330 often includes a plurality of lenses or lens groups. The optical system 330 may be composed of any number of lens groups.

A diaphragm 320 has an aperture. The amount of light of a subject image to be formed by the interchangeable lens 300 is regulated by adjusting a size of the aperture. The diaphragm drive motor 321 drives the diaphragm 320 to vary the aperture of the diaphragm 320 under control of the lens controller 310.

The lens controller 310 controls the entire interchangeable lens 300 according to a control signal from the camera body 200. The lens controller 310 may be configured by a microcomputer or a hard wired circuit device.

The lens-side connecting unit 360 is a device for transmitting/receiving an electrical signal to/from the body-side connecting unit 260. The lens-side connecting unit 360 also accepts power provided from the body-side connecting unit 260 and supplies the power to the interchangeable lens 300.
1-4. Correspondence

The CMOS image sensor 220 is an example of an imaging element. The camera controller 210, the power controller 241 and/or the lens controller 310 are an example of a control device. The diaphragm drive motor 321 is an example of a diaphragm drive device.

### 2. Operation

2-1. Operation performed upon Power-Off

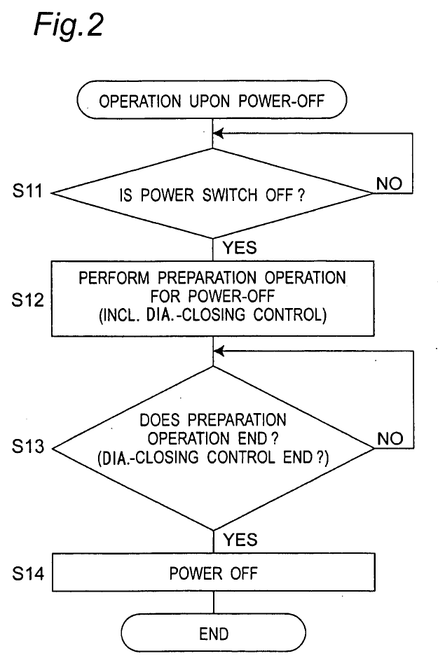

An operation of the digital camera system 100 configured in the above-described manner, performed upon power-off will be described with reference to FIG. 2. FIG. 2 is a flowchart for describing an operation of the camera system 100 performed upon power-off.

While the camera system 100 is in operation, the power controller 241 monitors whether the power switch 242 is operated to off (S11). If the power switch 242 is operated to off, then the power controller 241 notifies the camera controller 210 that the power switch 242 has been operated to off.

The camera controller 210 transmits an instruction to perform an operation for power-off (hereinafter, referred to as a “power-off preparation instruction”), to the lens controller 310 through the body-side connecting unit 260 and the lens-side connecting unit 360. When the lens controller 310 receives the power-off preparation instruction, the lens controller 310 starts a preparation operation for power-off (S12). The preparation operation for power-off includes specifically an operation for bringing the optical system 330 into a predetermined state, and so on. Particularly, in the present embodiment, the preparation operation for power-off includes an adjustment of the aperture of the diaphragm 320. More specifically, when the lens controller 310 receives the power-off preparation instruction from the camera controller 210, the lens controller 310 controls the diaphragm drive motor 321 such that the aperture of the diaphragm 320 is narrowed to a predetermined value (S12). For example, the lens controller 310 controls the diaphragm 320 so that f-number is 22. Alternatively, the lens controller 310 may control the aperture of the diaphragm 320 such that the amount of light passing through the diaphragm 320 is minimized. At this time, the diaphragm 320 may be configured such that the amount of light passing therethrough is zero when the aperture of the diaphragm 320 is narrowed to the maximum extent possible.

When the preparation operation for power-off has been completed in the interchangeable lens 300, the lens controller 310 sends back a response signal indicating the completion of the preparation operation for power-off to the camera controller 210. In response to the response signal, the camera controller 210 notifies the power controller 241 that power-off is enabled if a preparation operation for power-off has also been completed in the camera body 200 (S13).

Finally, in response to the notification from the camera controller 210 that power-off is enabled, the power controller 241 stops supply of power from the power supply 240 (S14).

As described above, in the present embodiment, when power to the camera body 200 is attempted to be turned off, the aperture of the diaphragm 320 is adjusted to be narrowed and then the power is turned off. Accordingly, even when a lens lid is not put on the interchangeable lens 300 after power-off, the amount of light reaching the CCD image sensor 220 (imaging element) from the outside of the camera system 100 through the interchangeable lens 300 can be reduced and thus deterioration of the CCD image sensor 220 or color filters in the CCD image sensor 220, can be prevented.
2-2. Operation performed upon Power-On

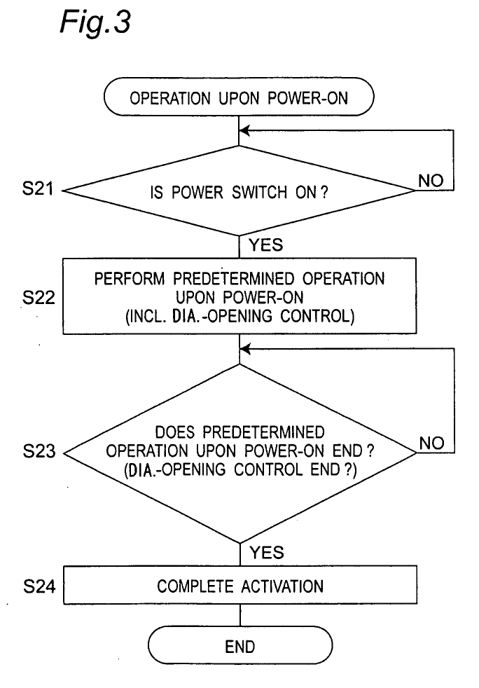

Next, an operation performed upon power-on will be described with reference to FIG. 3. FIG. 3 is a flowchart for describing an operation of the camera system 100 performed upon power-on.

While power to the camera system 100 is off, the power controller 241 monitors whether the power switch 242 is operated to on (S21). The power controller 241 operates with a power supply different from a power supply of the camera body 200. Thus even when the camera body 200 is in a power-off state, the power controller 241 is operable. If the power switch 242 is operated to on, then the power controller 241 controls the power supply 240 to start supply of power. The power controller 241 notifies the camera controller 210 that the power switch 242 has been operated to on.

The camera controller 210 transmits an instruction to perform a predetermined operation for power-on (hereinafter, referred to as an “on-operation start instruction”) to the lens controller 310 through the body-side connecting unit 260 and the lens-side connecting unit 360. When the lens controller 310 receives the on-operation start instruction, the lens controller 310 starts a predetermined operation for power-on (activation) (S22). The predetermined operation for power-on specifically includes an operation for bringing the optical system 330 into a predetermined state, and so on. Particularly, the predetermined operation for power-on includes an adjustment of the diaphragm 320. Specifically, when the lens controller 310 receives the on-operation start instruction from the camera controller 210, the lens controller 310 controls the diaphragm drive motor 321 to open the diaphragm 320 so that a larger amount of light passes through the diaphragm 320 than that during power-off of the camera system (S22).

When the operation for power-on has been completed in the interchangeable lens 300 (S23), the lens controller 310 sends back a reply indicating the completion of the operation for power-on to the camera controller 210. Thus, the predetermined operation for activation is completed (S24) and the camera controller 210 can record an image while controlling the interchangeable lens 300.

### 3. Conclusion

As described above, when the power is about to be turned off, the digital camera system 100 according to the first embodiment narrows the diaphragm 320, thereby reducing the amount of light incident to the CMOS image sensor 220 through the interchangeable lens 300 during power-off of the camera system. Therefore, inconvenience that color filters in the CMOS image sensor 220 are deteriorated by intense light incident to the CMOS image sensor 220 during the power-off can be reduced.

Such measures against deterioration of the CMOS image sensor 220 are particularly useful for lens-interchangeable camera systems that do not have a movable mirror between an optical system 330 and a CMOS image sensor 220. Normally, in a camera system that has a movable mirror, in power off operation, the power is turned off after the movable mirror is controlled to enter an optical path. Thus, incident light through an interchangeable lens 300 reaches a CMOS image sensor 220 with the intensity of the light being weakened to a considerable extent. Therefore, deterioration of an imaging element caused by the above-described factor is less likely to occur in the camera system having a movable mirror. In the camera system according to the present embodiment, no movable mirror is provided in an optical path between an optical system and an imaging element. The shutter is kept open in a normal state and a moving image is displayed on the viewfinder 270 or LCD monitor 230, so that determination of picture composition upon recording a still image can be done. Therefore, when the operator happens to forget to put a cap on the interchangeable lens 300 during the power-off, incident light through the interchangeable lens 300 would reach the imaging element with the light not weakened much. In a camera having such a configuration, deterioration such as fading of color filters due to exposure for a long period of time may occur in the imaging element. For such a reason, the measures of narrowing an aperture of a diaphragm upon power-off of the camera system is useful particularly for a lens-interchangeable camera that does not have a movable mirror.

Note that although in the above-described configuration the diaphragm 320 and the diaphragm drive motor 321 are provided in the interchangeable lens 300, they may be provided in the camera body 200. In this case, upon power-off, the camera controller 210 may control the diaphragm drive motor to narrow the aperture of the diaphragm. The interchangeable lens 300 may send back information indicating that a power-off preparation operation for control other than control of the diaphragm has been completed, to the camera controller 210.

### Second Embodiment

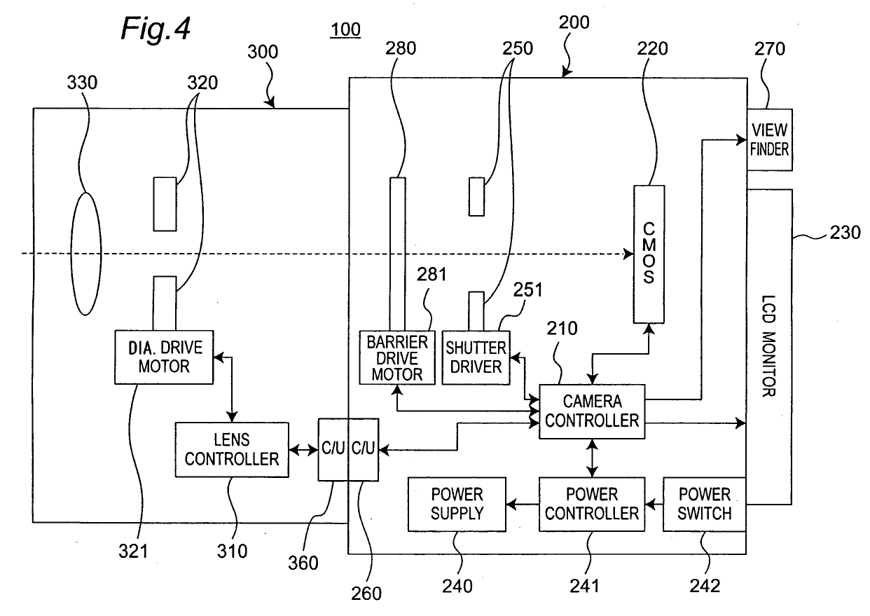

FIG. 4 is a block diagram showing a configuration of a camera system according to a second embodiment. As shown in FIG. 4, a camera body 200 further includes a barrier mechanism 280 and a barrier drive motor 281 for driving the barrier mechanism 280. Inthe first embodiment, the aperture of the diaphragm 320 is narrowed upon power-off. In the present embodiment, the camera controller 210 controls the barrier drive motor 281 to close the barrier mechanism 280 when the power is turned off. Then, after the barrier mechanism 280 is closed, the camera controller 210 notifies a power controller 241 that power-off is enabled. When receiving the notification from the camera controller 210 that power-off is enabled, the power controller 241 stops supply of power from a power supply 240.

The barrier mechanism 280 is provided in the middle of an optical path extending from an optical system in the interchangeable lens 300 to the CMOS image sensor 220, and is a mechanically openable and closable mechanism. The barrier mechanism 280 is provided to close an aperture of a connecting portion in the camera body 200 with the interchangeable lens 300. That is, the barrier mechanism 280 being in a closed state functions as a protective cover for the aperture of the connecting portion in the camera body 200 with the interchangeable lens 300. By bringing the barrier mechanism 280 into a closed state, light incident to the camera body 200 from the outside through the interchangeable lens 300 can be cut off and entrance of foreign matter such as dust entering the camera body 200 can also be prevented. Particularly, when the interchangeable lens 300 is detached from the camera body 200, the barrier mechanism 280 being in a closed state effectively functions to prevent foreign matter from entering the camera body 200.

It is preferred that the barrier mechanism 280 is made to completely cut off incident light through the interchangeable lens 300. However the barrier mechanism 280 does not need to completely cut off incident light through the interchangeable lens 300 and it may be configured to reduce the light to a predetermined amount of light or less.

### Other Variants

The first and second embodiments are shown above. However, an embodiment is not limited to the content disclosed in the first to third embodiments. The following variants are also encompassed in the application range of the idea of the present embodiment.

In the first and second embodiments, the power is turned off according to an operation performed on the power switch 242 by the operator. Then, upon power-off, a diaphragm and so on are controlled to reduce the amount of light incident to an imaging element from the outside through an interchangeable lens. Such control performed upon power-off can also be applied to the case in which the power is automatically turned off by the camera controller 210 (auto power-off). Such control performed upon power-off can be applied not only to the case in which power to the entire camera system 100 is turned off but also to the case in which supply of power is partially stopped. For example, control performed upon power-off according to the first and second embodiments is also applied to the case in which the operator does not perform any operation on the camera body 200 for a predetermined period of time and thus the camera system 100 goes into a sleep mode to stop supply of power to a LCD monitor, and so on.

Although in the first and second embodiments, the camera body 200 including both the LCD monitor 230 and the electronic viewfinder 270 is exemplified, the arrangement is not limited thereto. For example, a camera may include either one of the LCD monitor 230 and the electronic viewfinder 270.

### INDUSTRIAL APPLICABILITY

According to the aforementioned embodiments, by narrowing an aperture of a diaphragm or closing a barrier mechanism, and so on, upon power-off, the amount of light incident to an imaging element from the outside through an interchangeable lens is reduced, so that deterioration of filters in the imaging element can be reduced. Accordingly, the aforementioned embodiments are useful for digital still cameras, digital movie cameras, and so on, for capturing an image using an imaging element.

Although the aforementioned description has been provided in connection with specified embodiments thereof, many other modifications, corrections and applications are apparent to those skilled in the art. Therefore, the embodiments are not limited by the disclosure provided herein. The present disclosure relates to subject matter contained in Japanese Patent Application No. 2008-086056, filed on Mar. 28, 2008, which is expressly incorporated herein by reference in its entirety.

What is claimed is:

1. A camera system including a camera body and an interchangeable lens, the camera system comprising:
an optical system operable to collect light from a subject to form a subject image;
a diaphragm with an aperture operable to regulate an amount of the light collected by the optical system which passes through the diaphragm;
a diaphragm driver operable to drive the diaphragm;
an imaging element operable to capture the subject image formed by the optical system to generate image data;
a power supply operable to supply power to the camera body and the interchangeable lens; and
a controller operable to control the power supply, wherein
when the supply of power from the power supply is requested to be stopped, the controller controls the diaphragm driver to adjust the aperture of the diaphragm such that an amount of light passing through the diaphragm is no greater than a predetermined value, and thereafter the controller controls the power supply to stop the supply of power.

2. The camera system according to claim 1, wherein the predetermined value is a minimum value of the amount of light that can be regulated by the diaphragm.

3. The camera system according to claim 1, wherein the camera system does not have a movable mirror disposed in an optical path between the optical system and the imaging element.

4. The camera system according to claim 1, wherein the supply of power from the power supply is requested to be stopped when the controller receives a power-off instruction.

5. The camera system according to claim 4, wherein the power-off instruction is received by the controller when a power switch provided on the camera body is operated.

6. The camera system according to claim 4, wherein the power-off instruction is received by the controller when the camera system enters a sleep mode.

7. The camera system according to claim 6, wherein the camera system enters the sleep mode when no operation is performed on the camera body for a predetermined period of time.

8. A camera system comprising a camera body and an interchangeable lens, wherein
the interchangeable lens includes an optical system operable to collect light from a subject to form a subject image,
the camera body includes:
a power supply operable to supply power to the camera body;
an imaging element operable to capture the subject image formed by the interchangeable lens to generate image data;
a barrier mechanism operable to cut off or reduce light incident through the interchangeable lens;
a barrier driver operable to drive the barrier mechanism; and
a controller operable to control an operation of the camera body;
when the supply of power from the power supply is requested to be stopped, the controller controls the barrier driver to drive the barrier mechanism to cut off or reduce light incident through the interchangeable lens, and thereafter controls the power supply to stop the supply of power.

9. The camera system according to claim 8, wherein the supply of power from the power supply is requested to be stopped when the controller receives a power-off instruction.

10. The camera system according to claim 9, wherein the power-off instruction is received by the controller when a power switch provided on the camera body is operated or when the camera system enters a sleep mode.

11. A camera body to which an interchangeable lens for forming a subject image is mountable, the interchangeable lens including a diaphragm having an aperture for regulating an amount of light passing through the diaphragm, the camera body comprising:
an imaging element operable to capture the subject image formed by the interchangeable lens to generate image data;
a power supply operable to supply power to the camera body; and
a controller operable to control the power supply, wherein
when the supply of power from the power supply is requested to be stopped, the controller transmits, to the interchangeable lens, a control signal for adjusting the aperture of the diaphragm such that an amount of light passing through the diaphragm of the interchangeable lens is no greater than a predetermined value, and after receiving, from the interchangeable lens, a signal indicating that the adjustment to the diaphragm has been completed, the controller controls the power supply to stop the supply of power.

12. The camera body according to claim 11, wherein the supply of power from the power supply is requested to be stopped when the controller receives a power-off instruction.

13. The camera body according to claim 12, wherein the power-off instruction is received by the controller when a power switch provided on the camera body is operated or when the camera body enters a sleep mode.

14. A camera body to which an interchangeable lens is mountable, the camera body comprising:
a diaphragm with an aperture operable to regulate an amount of light of a subject image which is collected by the interchangeable lens;
a diaphragm driver operable to drive the diaphragm;
an imaging element operable to capture the subject image formed by the interchangeable lens to generate image data;
a power supply operable to supply power to the camera body; and
a controller operable to control the power supply, wherein
when the supply of power from the power supply is requested to be stopped, the controller controls the diaphragm driver to adjust the aperture of the diaphragm such that an amount of light passing through the diaphragm is no greater than a predetermined value, and thereafter controls the power supply to stop the supply of power.

15. The camera body according to claim 14, wherein the supply of power from the power supply is requested to be stopped when the controller receives a power-off instruction.

16. The camera body according to claim 15, wherein the power-off instruction is received by the controller when a power switch provided on the camera body is operated or when the camera body enters a sleep mode.

17. A camera body to which an interchangeable lens is mountable, the camera body comprising:
a power supply operable to supply power to the camera body;
an imaging element operable to capture a subject image formed by the interchangeable lens to generate image data;
a barrier mechanism operable to cut off or reduce light incident through the interchangeable lens;
a barrier driver operable to drive the barrier mechanism; and
a controller operable to control an operation of the camera body, wherein
when the supply of power from the power supply is requested to be stopped, the controller controls the barrier driver to drive the barrier mechanism to cut off or reduce the light incident through the interchangeable lens, and thereafter controls the power supply to stop the supply of power.

18. The camera body according to claim 17, wherein the supply of power from the power supply is requested to be stopped when the controller receives a power-off instruction.

19. The camera body according to claim 18, wherein the power-off instruction is received by the controller when a power switch provided on the camera body is operated or when the camera body enters a sleep mode.
